(19) United States
(12) Patent Application Publication
(10) Pub. No.: US 2019/0366461 A1
(43) Pub. Date: Dec. 5, 2019

(54) APPLYING APPARATUS AND APPLYING METHOD

(71) Applicant: DENSO TEN Limited, Kobe-shi (JP)

(72) Inventor: Hisaki Hayashi, Kobe-shi (JP)

(73) Assignee: DENSO TEN Limited, Kobe-shi (JP)

(21) Appl. No.: 16/363,063

(22) Filed: Mar. 25, 2019

(30) Foreign Application Priority Data
May 31, 2018 (JP) 2018-104524

(51) Int. Cl. B23K 3/08

(52) U.S. Cl. CPC B23K 3/082

(57) ABSTRACT

An applying apparatus according to one embodiment of the invention includes an application liquid nozzle, a wall and an air nozzle. The application liquid nozzle sprays an application liquid onto a predetermined area of a board. The wall is arranged so as to surround the predetermined area of the board, and includes a flow channel through which the application liquid that has been sprayed from the application liquid nozzle flows to the predetermined area. The air nozzle is provided adjacent to the wall, and sprays air onto the board.

### BACKGROUND OF THE INVENTION

### Field of the Invention

The invention relates to an applying apparatus and an applying method.

### Description of the Background Art

Conventionally, when components, and the like, are soldered to a printed wiring board, as a pre-process of soldering, there is a known technology that removes an oxide film by applying an application liquid, such as a flux liquid, to the board.

In the conventional technology, in order to prevent the application liquid from being scattered on an area other than a predetermined area to which the application liquid should be applied on the board, for example, the application liquid has been applied in a state in which the predetermined area of the board is surrounded by a wall and masked.

However, in the conventional technology, there is still room for improvement in preventing the application liquid from being scattered on an area to which the application liquid should not be applied on the board.

### SUMMARY OF THE INVENTION

According to one aspect of the invention, an applying apparatus includes an application liquid nozzle that sprays an application liquid onto a predetermined area of a board, a wall that is arranged so as to surround the predetermined area of the board, and includes a flow channel through which the application liquid that has been sprayed from the application liquid nozzle flows to the predetermined area, and an air nozzle that is provided adjacent to the wall, and sprays air onto the board.

As a result, the application liquid is prevented from being scattered on an area to which the application liquid should not be applied.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is a diagram illustrating an outline of an applying apparatus according to an embodiment;

FIG. 2 is a block diagram illustrating a configuration example of an applying system including the applying apparatus;

FIG. 3 is a plan view of the applying apparatus;

FIG. 4 is a cross-sectional view along a line IV-IV of FIG. 3;

FIG. 5 is a flowchart illustrating a process procedure executed by the applying apparatus;

FIG. 6 is a partially enlarged plan view of an applying apparatus according to a first modification; and

FIG. 7 is a partially enlarged cross-sectional view of an applying apparatus according to a second modification.

### DESCRIPTION OF THE EMBODIMENTS

Embodiments of an applying apparatus and an applying method disclosed in the application will be hereinafter described in detail with reference to accompanying drawings. The invention is not limited to the embodiments described below.

<1. Outline of Applying Apparatus>

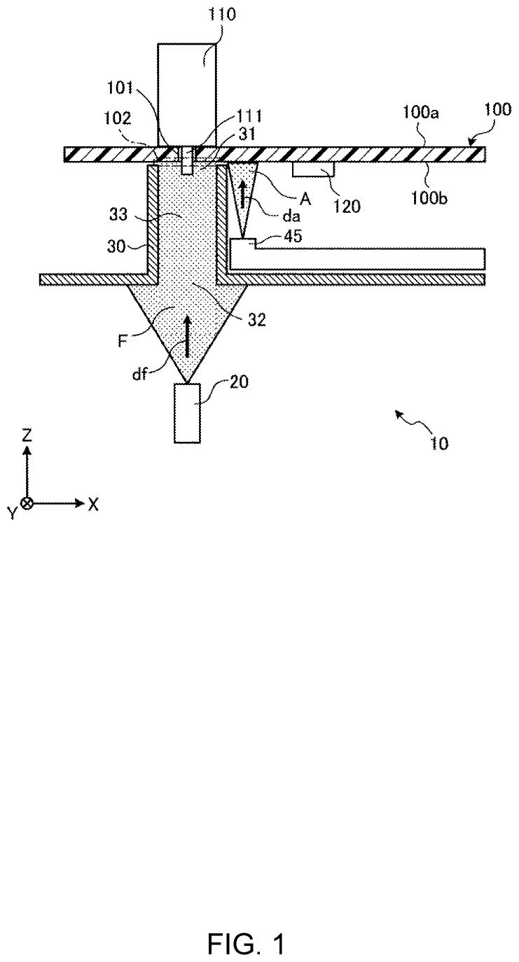

First, description will be made hereinafter on an outline of the applying apparatus according to an embodiment with respect to FIG. 1. FIG. 1 is a diagram illustrating the outline of the applying apparatus according to the embodiment.

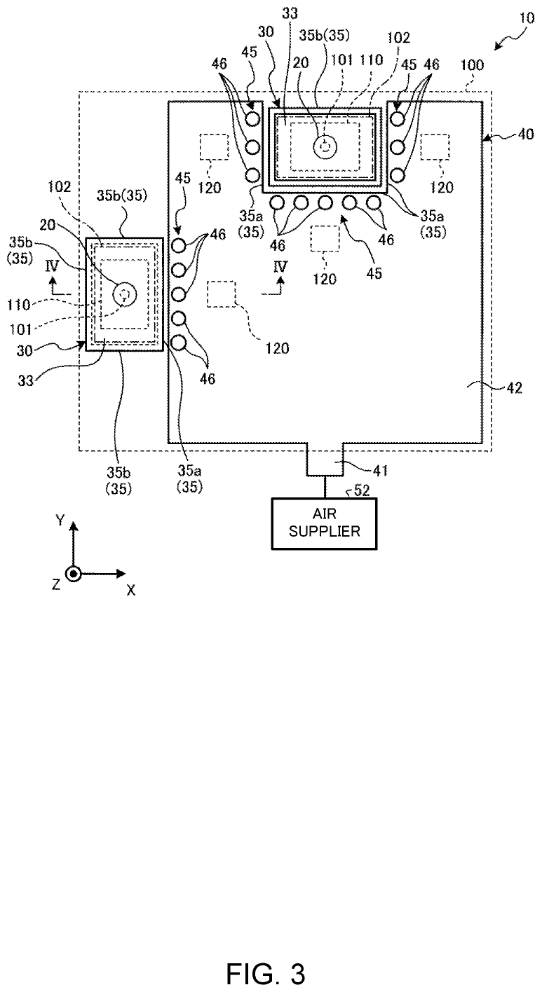

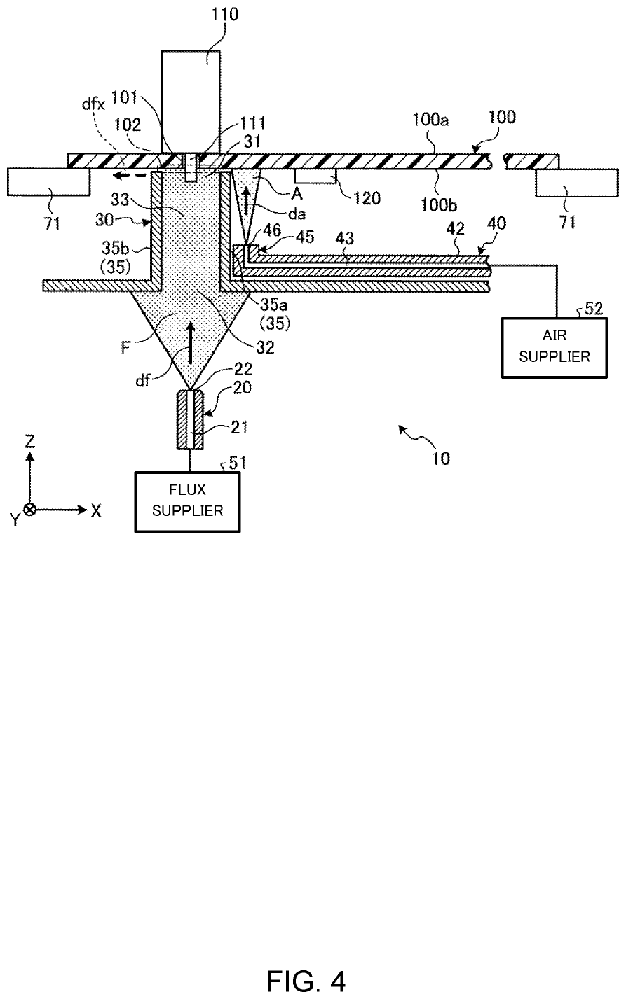

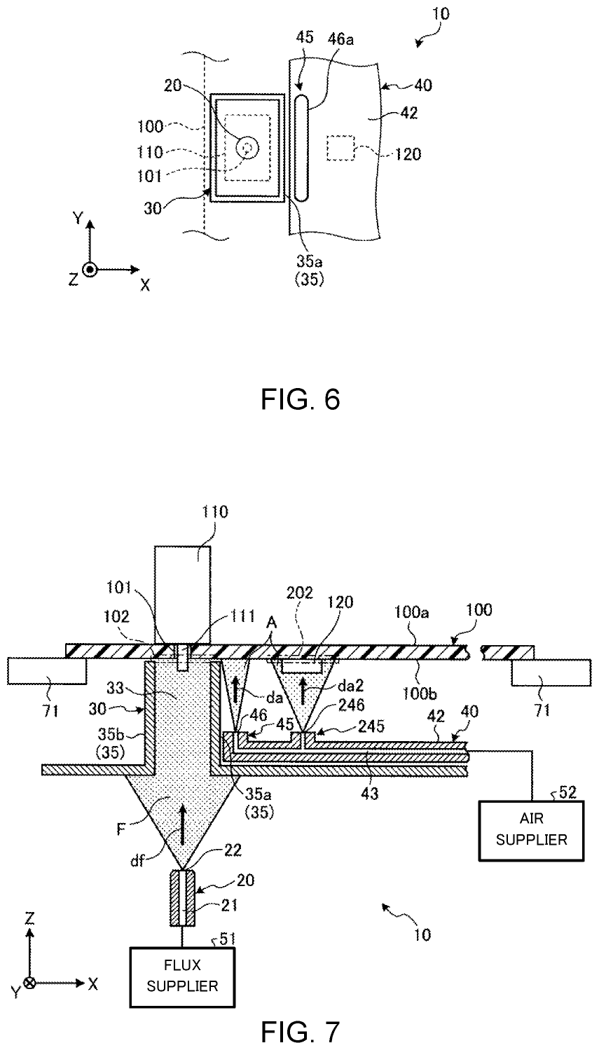

FIG. 1 shows a three-dimensional orthogonal coordinate system that includes an X axis, a Y axis and a Z axis that is a vertical axis. Such a three-dimensional orthogonal coordinate system may also be shown in other drawings described later. FIG. 1, and FIG. 3, FIG. 4, FIG. 6 and FIG. 7 described later are all schematic diagrams. Therefore, a size, a shape, etc. of each constituent element shown in FIG. 1, and the like, are not necessarily accurate. In each drawing, in order to facilitate understanding, each constituent element may be exaggerated.

As illustrated in FIG. 1, an applying apparatus 10 applies an application liquid to a board 100. Hereinafter, a case in which a flux liquid (hereinafter, referred to as a “flux”) is used as the application liquid will be described as an example.

The applying apparatus 10 includes a flux nozzle 20, a wall 30 and an air nozzle 45. The flux nozzle 20 is one example of an application-liquid nozzle.

Here, before proceeding with description of the applying apparatus 10, the board 100 will be described. As the board 100, for example, a printed wiring board (not shown) can be used. The board 100 is not limited to the printed wiring board, and other types of boards may be used.

A component 110, a component 120, and other various components including electronic components are mounted on the board 100. In an example shown in FIG. 1, the component 120 is mounted on a back surface 100b that is a main surface on a vertical lower side (negative direction side of the Z axis) of the board 100 while the component 110 is mounted on a front surface 100a that is a main surface on a vertical upper side (positive direction side of the Z axis) of the board 100.

As described above, since the component 120 is mounted on the back surface 100b of the board 100, the component 120 may be hereinafter referred to as a “back surface component 120”. As described later, since the flux is applied to the back surface 100b of the board 100, the back surface 100b may be hereinafter referred to as an “application surface 100b”.

The component 110 is soldered and mounted on the board 100 in a state in which a lead pin 111 is inserted through a through hole 101 that is formed in the board 100. However, FIG. 1 shows a state before the component 110 is soldered to the board 100. FIG. 1 also shows a state in which the back surface component 120 is mounted on the board 100, for example, by surface mounting, and the like.

When the component 110 is soldered to the board 100, as a pre-process of soldering, the flux is applied to the board 100. On the board, by applying the flux to the board 100, for example, an oxide film is removed, and soldering wettability is improved.

Specifically, it is preferable that the flux be applied to a predetermined area 102 including the through hole 101 in which soldering is performed on the application surface (back surface) 100b of the board 100. Therefore, it can be said that the predetermined area 102 of the board 100 is an area to which the flux should be applied. In order to facilitate understanding, the predetermined area 102 is indicated by a long dashed and short dashed line in FIG. 1.

However, for example, when the flux is scattered on an area other than the predetermined area 102, there is a possibility that the flux adheres to the back surface component 120, and the like, that are mounted near the predetermined area 102 so as to cause a negative effect.

Thus, the applying apparatus 10 according to the embodiment is configured to prevent the flux from being scattered on the area to which the flux should not be applied, such as the area in which, for example, the back surface component 120 is mounted.

Specifically, the flux nozzle 20 of the applying apparatus 10 sprays the flux. For example, the flux nozzle 20 is arranged below the board 100, specifically, in a position a predetermined distance away below the predetermined area 102 of the board 100.

The flux nozzle 20 sprays the flux upwardly as indicated by an arrow df, specifically, onto the predetermined area 102 of the board 100. In FIG. 1, the flux sprayed from the flux nozzle 20 is indicated by dots and a sign F is denoted.

The wall 30 is arranged so as to surround the predetermined area 102 of the board 100 and is a member that is used for masking the board 100. For example, the wall 30 has a tubular shape and is provided with an aperture 31 on an upper end side while being provided with an aperture 32 on a lower end side.

The wall 30 is arranged proximity to the board 100 while the aperture 31 on the upper end side is arranged in a position corresponding to the predetermined area 102 of the board 100. The wall 30 is positioned between the board 100 and the flux nozzle 20 and a flux F is sprayed from the flux nozzle 20 to the aperture 32 on the lower end side.

As a result, inside the wall 30, a flow channel 33 through which the flux F that has been sprayed from the flux nozzle 20 flows from the aperture 32 to the aperture 31 is formed. As described above, since the aperture 31 is arranged in the position corresponding to the predetermined area 102 of the board 100, the flow channel 33 of the wall 30 leads the flux F sprayed from the flux nozzle 20 to the predetermined area 102.

The air nozzle 45 sprays air. For example, the air nozzle 45 is provided adjacent to the wall 30. Specifically, the air nozzle 45 is provided adjacent to a side of the wall 30 (right side (positive direction side of the X axis) in the example shown in FIG. 1) that is adjacent to the back surface component 120 that is mounted on the application surface 100b of the board 100. In other words, the air nozzle 45 is provided adjacent to the side of the wall 30 that is adjacent to an area to which the flux F should not be applied. An arrangement position of the air nozzle 45 shown in FIG. 1 is merely an example, and is not limited thereto.

The air nozzle 45 sprays air onto the board 100, specifically, as indicated by an arrow da, along the wall 30 onto the upper board 100. In FIG. 1, the air sprayed from the air nozzle 45 is indicated by dots with lower density than the flux F and a sign A is denoted.

As described above, in this embodiment, the air nozzle 45 is provided adjacent to the wall 30, and air A is sprayed onto the board 100. As a result, for example, an air wall (air curtain) that blocks the flux F from flowing out between the board 100 and the wall 30 and flowing to a side of the air nozzle 45 is formed by the sprayed air A, and the flux F is prevented from being scattered beyond the air wall by the air nozzle 45.

Therefore, even when the back surface component 120 is mounted on the area other than the predetermined area 102 like the board 100 shown in FIG. 1, the air nozzle 45 is provided adjacent to the side of the wall 30 that is adjacent to the back surface component 120 that is mounted and the air A is sprayed, so that the flux F is hardly scattered on the back surface component 120. That is, the flux F is prevented from being scattered on an area to which the flux F should not be applied on the board 100. As a result, for example, it is possible to prevent the flux F from adhering to the back surface component 120 and causing a negative effect.

Furthermore, in this embodiment, it is also possible to prevent the flux F from bleeding out of the predetermined area 102. That is, for example, drying of the flux F is accelerated by the air A that is sprayed from the air nozzle 45. Specifically, the air A is easily applied to an end portion of the flux F that has been applied to the predetermined area 102 on a side (right side in the example in FIG. 1) on which the air nozzle 45 is provided. Therefore, in a vicinity of the end portion of the flux F, an alcohol component (e.g., isopropyl alcohol) included in the flux F is easily evaporated, so that drying of the flux F is accelerated.

As described above, drying in the vicinity of the end portion of the flux F applied to the predetermined area 102 is accelerated, so that the flux F is less likely to flow out of the predetermined area 102. As a result, it is possible to prevent the flux F from bleeding out of the predetermined area 102 (specifically, the area to which the flux F should not be applied).

Although not shown in the drawings, when application of the flux F to the board 100 is completed, the board 100 is conveyed to a next process and the component 110 is soldered to an area (here, the predetermined area 102) to which the flux F has been applied.

<2. Configuration of Applying System Including Applying Apparatus>

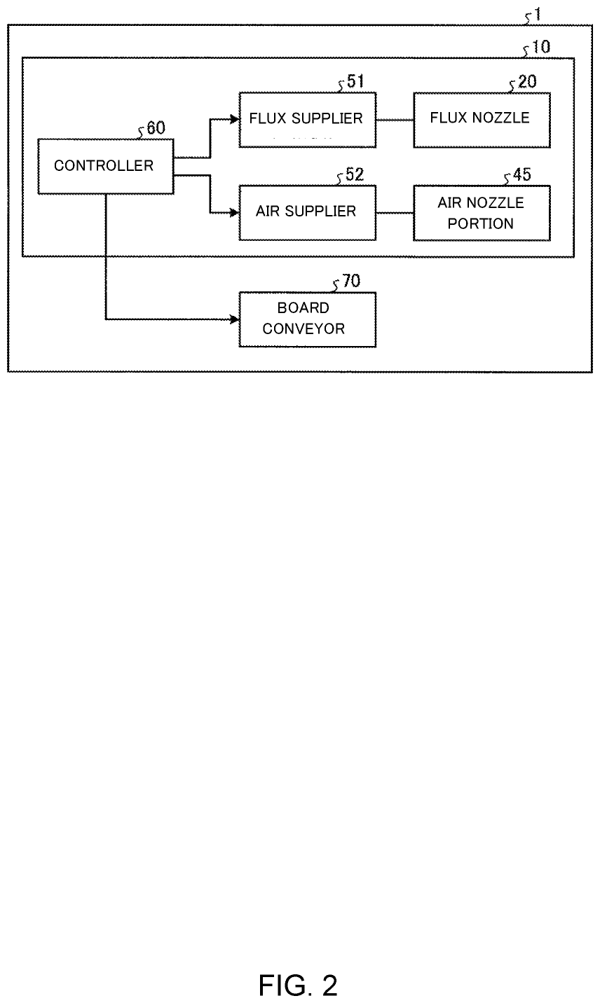

Next, a configuration of an applying system 1 of the applying apparatus 10 according to the embodiment will be described with reference to FIG. 2. FIG. 2 is a block diagram illustrating a configuration example of the applying system 1 including the applying apparatus 10.

As shown in FIG. 2, the applying system 1 includes the applying apparatus 10 and a board conveyor 70. The board conveyor 70 conveys the board 100 (refer to FIG. 1). For example, the board conveyor 70 conveys the board 100 placed on a palette 71 (refer to FIG. 4 described later), or the like, to a predetermined position in which the application of the flux is performed by the applying apparatus 10, and conveys the board 100 from the predetermined position to a position in which soldering of the next process is performed.

In the above, the board 100 is conveyed by the board conveyor 70, but is not limited thereto. For example, without using the board conveyor 70, the applying apparatus 10 may be moved to the board 100, or the board 100 may be conveyed by a worker.

The applying apparatus 10 includes the flux nozzle 20, the air nozzle 45, a flux supplier 51, an air supplier 52 and a controller 60.

The flux supplier 51 supplies the flux to the flux nozzle 20. Although not shown in the drawings, for example, the flux supplier 51 includes a tank in which the flux is stored and a pump, and the like. The flux supplier 51 pressure-feeds and supplies the flux that is stored in the tank to the flux nozzle 20 by driving of the pump.

The air supplier 52 supplies air to the air nozzle 45. Although not shown in the drawings, for example, the air supplier 52 includes an air pump, a flow regulator, and the like. The air supplier 52 pressure-feeds and supplies air to the air nozzle 45 by driving of the air pump, and regulates a flow rate of air that is supplied to the air nozzle 45 by the flow regulator.

The controller 60 is a microcomputer including a central processing unit (CPU), a memory, and the like, and controls entire of the applying system 1. For example, the controller 60 controls the flux supplier 51, the air supplier 52, the board conveyor 70, and the like.

Specifically, the controller 60 starts and stops spraying of the flux to the board 100 from the flux nozzle 20 by controlling operation of the pump, and the like, in the flux supplier 51 so as to control flux spraying operation of the flux nozzle 20.

The controller 60 controls operation of the air pump, the flow regulator, and the like, in the air supplier 52. As a result, the controller 60 controls air spraying operation of the air nozzle 45 by starting spraying of air to the board 100 from the air nozzle 45 and regulating the flow rate of air, and stopping spraying of air.

In the controller 60, when the flux is sprayed, the flow rate of the air that is sprayed from the air nozzle 45 is set, for example, according to a flow rate of the flux. For example, the flow rate of air is set to be equal to or higher than the flow rate of the flux. As a result, the air wall that blocks the flux from flowing out to the side of the air nozzle 45 is formed (refer to FIG. 1), and the flux is prevented from being scattered beyond the air wall.

For example, regardless of whether or not the flux is sprayed, the controller 60 may control the air spraying operation to cause air to be always sprayed from the air nozzle 45. As a result, for example, the flux, dust, or the like, is less likely to enter a spray opening 46 (refer to FIG. 3 described later) of the air nozzle 45, so that clogging is prevented.

For example, the controller 60 may control the air spraying operation to change the flow rate of the air that is sprayed from the air nozzle 45 between a first flow rate at a spray time during which the flux is sprayed by the flux nozzle 20 and a second flow rate at a non-spray time during which the flux is not sprayed. That is, for example, when the flow rate of air at the spray time during which the flux is sprayed is a “first predetermined flow rate Q1”, and the flow rate of air at the non-spray time during which the flux is not sprayed is a “second predetermined flow rate Q2”, the first predetermined flow rate Q1 and the second predetermined flow rate Q2 may be set to different values.

Specifically, the controller 60 changes the flow rate of the air that is sprayed from the air nozzle 45 so that the second predetermined flow rate Q2 that is the flow rate of air at the non-spray time of the flux is higher than the first predetermined flow rate Q1 that is the flow rate of air at the spray time of the flux (Q2>Q1). As a result, for example, the flux, dust, or the like, is less likely to enter the spray opening 46 of the air nozzle 45 at the non-spray time of the flux, so that clogging is effectively prevented.

In the above, the second predetermined flow rate Q2 is set to be higher than the first predetermined flow rate Q1, but is not limited thereto. For example, the second predetermined flow rate Q2 may be set to be lower than the first predetermined flow rate Q1, or the second predetermined flow rate Q2 may be set to equal to the first predetermined flow rate Q1.

By controlling the board conveyor 70, the controller 60 controls conveyance of the board 100, such as conveying the board 100 to the predetermined position. In the above, the board conveyor 70 is controlled by the controller 60, but is not limited thereto. For example, the board conveyor 70 may be controlled by a different controller from the controller 60 that controls the flux supplier 51, and the like.

<3. Specific Configuration of Applying Apparatus>

Next, a specific configuration of the applying apparatus 10 according to the embodiment will be described with reference to FIG. 3 and FIG. 4. FIG. 3 is a plan view of the applying apparatus 10, and FIG. 4 is a cross-sectional view along a line IV-IV of FIG. 3. In FIG. 3, in order to facilitate understanding, the board 100, and the like, are indicated by a dashed line, and the air nozzle 45, and the like, that are positioned below the board, and the like, are shown.

As shown in FIG. 3, it is assumed that a plurality (here, two) of the components (110) and a plurality of (here, 4) of the back surface components (120) are mounted on the board (100). A number and mounting positions of the components (110) and the back surface components (120) shown in FIG. 3 are merely examples and not limited thereto.

As shown in FIG. 4, it is assumed that the board 100 is placed on the palette 71 (not shown in FIG. 3) and conveyed to a predetermined position above the flux nozzle 20 and the air nozzle 45.

As shown in FIG. 3 and FIG. 4, the applying apparatus 10 includes the flux nozzle 20, the wall 30 and an air conveyor 40 having the air nozzle 45.

The flux nozzle 20 is arranged below the predetermined area 102 including the through hole 101 of the board 100. As shown in FIG. 4, the flux nozzle 20 includes a flow channel 21 and a spray opening 22.

The flow channel 21 is connected to the flux supplier 51 and the flux that is supplied from the flux supplier 51 flows through the flow channel 21. The spray opening 22 is formed at an end portion of the flow channel 21, and the flux is sprayed from the spray opening 22 onto the predetermined area 102 of the board 100. The flux nozzle 20 is, for example, a spray type nozzle, but is not limited thereto.

The wall 30 is arranged below the board 100 so as to surround the predetermined area 102. As shown in FIG. 3, the wall 30 is, for example, a rectangular tube in a plan view, and the flow channel 33 through which the flux flows is formed inside the wall 30. A shape of the wall 30 shown in FIG. 3, and the like, is merely an example, and is not limited thereto. For example, the shape may be appropriately changed in accordance with, for example, a shape of the predetermined area 102.

Hereinafter, in a periphery 35 that is an outer peripheral surface of the wall 30, the periphery 35 in a position opposite to the back surface component 120 may be referred to as an “opposite periphery 35a” and the periphery 35 in a position not opposite to the back surface component 120 may be referred to as a “non-opposite periphery 35b”.

The air conveyor 40 includes an inflow portion 41, a flow channel portion 42, and the air nozzle 45. The inflow portion 41 is connected to the air supplier 52, and the air that is supplied from the air supplier 52 flows into the inflow portion 41.

The flow channel portion 42 has, for example, a hollow flat plate shape. The flow channel portion 42 is formed so that an inner space is communicated with the inflow portion 41. Therefore, the air that has flowed into the inflow portion 41 flows into the inner space of the flow channel portion 42 to form a flow channel 43 (refer to FIG. 4) through which the air flows inside the flow channel portion 42. A shape of the flow channel portion 42 shown in FIG. 3, and the like, is merely an example, and is not limited thereto.

The air nozzle 45 includes the spray opening 46. For example, the spray opening 46 is formed to be communicated with the flow channel 43 in the flow channel portion 42. Therefore, the air that flows through the flow channel 43 is sprayed from the spray opening 46.

In the air nozzle 45, a plurality of the spray openings 46 is formed so as to be continuously arranged in a row, but is not limited thereto. That is, for example, the plurality of the spray openings 46 may be arranged in a plurality of rows, or the spray opening 46 may be one opening only.

The spray opening 46 is a circular opening in a plan view, that is, a round hole. Thus, in this embodiment, the spray opening 46 is easily formed only by drilling the round hole in the flow channel portion 42. Furthermore, even when an opening area of the spray opening 46 is relatively small, air is sprayed over a wide range by appropriately setting the flow rate of air.

The air nozzle 45 having the spray opening 46 is provided adjacent to the wall 30. Specifically, the air nozzle 45 is provided adjacent to the side of the wall 30 that is adjacent to the back surface component 120 that is mounted on the application surface 100b of the board 100. In other words, the air nozzle 45 is provided adjacent to the opposite periphery 35a of the periphery 35 of the wall 30.

For example, as shown in FIG. 3, the air nozzle 45 is provided so that the plurality of the spray openings 46 is arranged along the periphery 35 (here, the opposite periphery 35a) of the wall 30.

When air is sprayed from the spray opening 46 of the air nozzle 45 having such a configuration onto the board 100, as shown in FIG. 4, for example, the air wall is formed along the periphery 35 (here, the opposite periphery 35a) of the wall 30. As a result, the flux is prevented from being scattered on the side of the air nozzle 45.

The air that has been sprayed from the air nozzle 45 and applied to the board 100 is less likely to flow to a side of the wall 30 in which the flux flows, so that the air flows to a side of the back surface component 120 that is mounted near the opposite periphery 35a. Therefore, the back surface component 120 itself is surrounded by the air, and thus, the flux is less likely to adhere to the back surface component 120. As a result, for example, it is possible to effectively prevent the flux F from adhering to the back surface component 120 and causing a negative effect.

In this embodiment, since there is a configuration in which the flux is less likely to adhere to the back surface component 120, for example, it is possible to mount the back surface component 120 near the predetermined area 102. Thus, it is possible to downsize the board 100 and also improve a degree of design freedom.

As shown in FIG. 3 and FIG. 4, the air nozzle 45 is provided adjacent to a part of the periphery 35 (here, the opposite periphery 35a) of the wall 30. In other words, the air nozzle 45 is not provided in a position adjacent to the non-opposite periphery 35b of the periphery 35 of the wall 30.

As a result, for example, the flux that has not flowed out between the opposite periphery 35a near which the air nozzle 45 is provided and the board 100, as indicated by a dashed arrow dfx in FIG. 4, is likely to flow out between the non-opposite periphery 35b near which the air nozzle 45 is not provided and the board 100. That is, the air nozzle 45 is not provided on a side of the non-opposite periphery 35b of the wall 30, so that a space from which the flux is easily released is formed.

As a result, for example, the flux may flow out between the non-opposite periphery 35b near which the air nozzle 45 is not provided and the board 100. However, since the back surface component 120 is not mounted on the side of the non-opposite periphery 35b, the flux does not adhere to the back surface component 120. Thus, it is possible to further effectively prevent the flux from adhering to the back surface component 120 and causing a negative effect.

In examples shown in FIG. 3, and the like, the air nozzle 45 is provided adjacent to a part of the periphery 35 of the wall 30, but is not limited thereto. The air nozzle 45 may be provided adjacent to the entire periphery 35 of the wall 30.

Although not shown in the drawings, for example, even when there is a step in the predetermined area 102 of the board 100 (printed wiring board), the wall 30 is arranged so as to surround the predetermined area 102 including the step, so that the flux is prevented from being scattered on the area other than the predetermined area 102 without being affected by the step.

The flow rate of the flux is appropriately changed in accordance with a size of the predetermined area 102, and the like. However, in this embodiment, since the flow rate of air is set according to the flow rate of the flux, the flux is prevented from being scattered on the side of the air nozzle 45 regardless of whether the flow rate of the flux increases or decreases.

Since the applying apparatus 10 according to this embodiment is simply configured to include the air nozzle 45, and the like, it is possible to produce the applying apparatus 10 at relatively low cost. In this embodiment, since a drive portion for moving the air nozzle 45 does not exist, an event that the drive portion is fixed by the flux does not occur, and thus, maintainability of the applying apparatus 10 is improved.

<4. Control Process of Applying Apparatus>

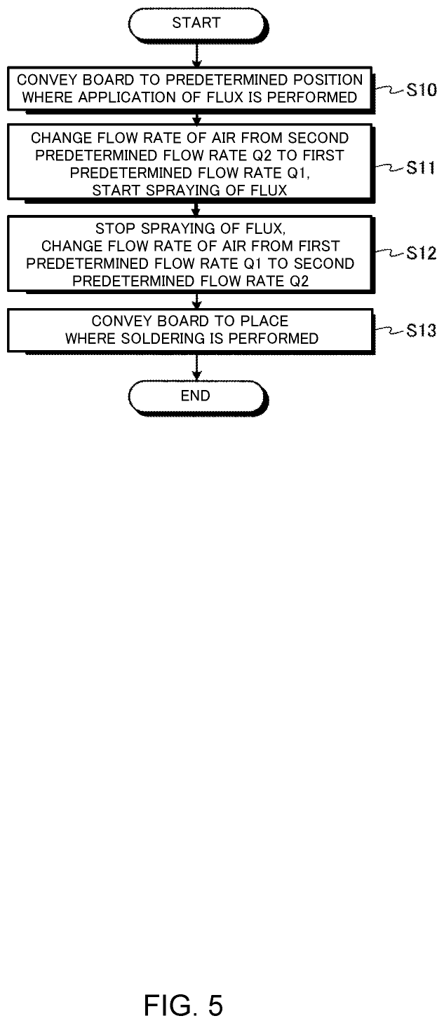

Next, a specific process procedure in the applying apparatus 10 will be described with reference to FIG. 5. FIG. 5 is a flowchart illustrating a process procedure executed by the applying apparatus 10.

As shown in FIG. 5, the controller 60 of the applying apparatus 10 controls the board conveyor 70 to convey the board 100 to the predetermined position in which the application of the flux is performed (a step S10). As described above, air is always sprayed from the air nozzle 45. Since the board 100 is conveyed at the non-spray time during which the flux is not sprayed, the flow rate of air is the second predetermined flow rate Q2.

Next, the controller 60 changes the flow rate of the air that is sprayed from the air nozzle 45 from the second predetermined flow rate Q2 to the first predetermined flow rate Q1 at the spray time of the flux, and starts spraying of the flux from the flux nozzle 20 (a step S11). As a result, the flux is applied to the predetermined area 102 of the board 100.

Next, when the application of the flux is completed, the controller 60 stops spraying of the flux from the flux nozzle 20, and changes the flow rate of the air that is sprayed from the air nozzle 45 from the first predetermined flow rate Q1 to the second predetermined flow rate Q2 (a step S12).

The controller 60 controls the board conveyor 70 to convey the board 100 to which the flux is applied, for example, to a place in which soldering of the next process is performed (a step S13).

As described above, the applying apparatus 10 according to the embodiment includes the flux nozzle 20 (one example of the application-liquid nozzle), the wall 30 and the air nozzle 45. The flux nozzle 20 sprays the flux (one example of the application liquid) onto the predetermined area 102 of the board 100. The wall 30 is arranged so as to surround the predetermined area 102 of the board 100, and inside the wall, the flow channel 33 through which the flux that has been sprayed from the flux nozzle 20 flows to the predetermined area 102 is formed. The air nozzle 45 is provided adjacent to the wall 30, and sprays air onto the board 100. As a result, in the applying apparatus 10, the flux is prevented from being scattered on the area to which the flux should not be applied.

<5. First Modification>

Next, a configuration of an applying apparatus 10 according to a first modification will be described with reference to FIG. 6. FIG. 6 is a partially enlarged plan view of the applying apparatus 10 according to the first modification. Hereinafter, same numerical references are given to same elements as the embodiment and description thereof is omitted.

In the first modification, a spray opening 46a of an air nozzle 45 is an elliptical opening in a plan view, that is, a long hole. For example, the spray opening 46a is a slit-shaped opening cut out in a position adjacent to a wall 30 in a flow channel portion 42, and is formed along a periphery 35 (e.g., an opposite periphery 35a) of the wall 30.

As described above, in the first modification, since the spray opening 46a of the air nozzle 45 is the elliptical opening in a plan view, air is sprayed over a wide range toward a board 100.

In an example shown in FIG. 6, one spray opening 46a is formed, but is not limited thereto. For example, two or more spray openings 46a may be formed.

<6. Second Modification>

Next, a configuration of an applying apparatus 10 according to a second modification will be described with reference to FIG. 7. FIG. 7 is a partially enlarged cross-sectional view of the applying apparatus 10 according to the second modification.

As shown in FIG. 7, the applying apparatus 10 according to the second modification includes an air nozzle potion 45 and a second air nozzle 245 that sprays air onto a back surface component 120.

Specifically, the second air nozzle 245 has a second spray opening 246. For example, the second spray opening 246 is communicated with a flow channel 43 in a flow channel portion 42. Therefore, the air that flows through the flow channel 43 is sprayed from the second spray opening 246.

Here, on an application surface 100b of a board 100, when an area, different from a predetermined area 102, in which the back surface component 120 is mounted is a “second predetermined area 202”, the second air nozzle 245, as indicated by an arrow da2, sprays air onto the back surface component 120 that is mounted on the second predetermined area 202.

As a result, in the second modification, air is sprayed from the second air nozzle 245 onto the back surface component 120, so that an air wall (air curtain) to surround the back surface component 120 with air is formed, and thus a flux is much less likely to adhere to the back surface component 120. Therefore, for example, it is possible to further effectively prevent the flux from adhering to the back surface component 120 and causing a negative effect.

In the first modification and the second modification, the flux is used as an application liquid for the board 100, but is not limited thereto. For example, other types of application liquids such as a coating liquid may be used.

It is possible for a person skilled in the art to easily come up with more effects and modifications. Thus, a broader modification of this invention is not limited to specific description and typical embodiments described and expressed above. Therefore, various modifications are possible without departing from the general spirit and scope of the invention defined by claims attached and equivalents thereof.

While the invention has been shown and described in detail, the foregoing description is in all aspects illustrative and not restrictive. It is therefore understood that numerous other modifications and variations can be devised without departing from the scope of the invention.

What is claimed is:

1. An applying apparatus comprising:
an application liquid nozzle that sprays an application liquid onto a predetermined area of a board;
a wall that is arranged so as to surround the predetermined area of the board, and includes a flow channel through which the application liquid that has been sprayed from the application liquid nozzle flows to the predetermined area; and
an air nozzle that is provided adjacent to the wall, and sprays air onto the board.

2. The applying apparatus according to claim 1, wherein
the air nozzle is provided adjacent to a part of an outer periphery of the wall.

3. The applying apparatus according to claim 1, wherein
the air nozzle is provided adjacent to a side of the wall that is adjacent to a component that is mounted on an application surface of the board.

4. The applying apparatus according to claim 1, wherein
the air nozzle includes a circular spray opening from which the air is sprayed.

5. The applying apparatus according to claim 1, further comprising
a controller that controls an air spraying operation of the air nozzle, the controller changing a flow rate of the air that is sprayed from the air nozzle between a first flow rate at a spray time during which the application liquid is sprayed by the application liquid nozzle and a second flow rate at a non-spray time during which the application liquid is not sprayed.

6. The applying apparatus according to claim 5, wherein
the controller changes the flow rate of the air that is sprayed from the air nozzle so that the second flow rate of the air at the non-spray time of the application liquid is higher than the first flow rate of the air at the spray time of the application liquid.

7. The applying apparatus according to claim 1, further comprising
a second air nozzle that sprays air onto a component that is mounted on a second predetermined area of the board, different from the predetermined area onto which the application liquid is sprayed.

8. An applying method comprising the steps of:
spraying an application liquid onto a predetermined area of a board by using (i) an application liquid nozzle that sprays the application liquid onto the predetermined area of the board and (ii) a wall that is arranged so as to surround the predetermined area of the board, and includes a flow channel through which the application liquid that has been sprayed from the application liquid nozzle flows to the predetermined area; and
spraying air onto the board by using an air nozzle that is provided adjacent to the wall.

9. The applying method according to claim 8, wherein
the air nozzle is provided adjacent to a part of an outer periphery of the wall and sprays the air adjacent to the outer periphery of the wall.

10. The applying method according to claim 8, wherein
the air nozzle is provided between an outer periphery of the wall and a component that is mounted on an application surface of the board.

11. The applying method according to claim 8, wherein
the air nozzle includes a circular spray opening from which the air is sprayed.

12. The applying method according to claim 8, wherein
a flow rate of the air that is sprayed from the air nozzle is changed between a first flow rate at a spray time during which the application liquid is sprayed by the application liquid nozzle and a second flow rate at a non-spray time during which the application liquid is not sprayed.

13. The applying method according to claim 12, wherein
the second flow rate of the air at the non-spray time of the application liquid is higher than the first flow rate of the air at the spray time of the application liquid.

14. The applying method according to claim 8, further comprising
spraying air onto a component that is mounted on a second predetermined area of the board, different from the predetermined area onto which the application liquid is sprayed.
